(19) United States
(12) Patent Application Publication
(10) Pub. No.: US 2015/0356397 A1
(43) Pub. Date: Dec. 10, 2015

(54) ANTENNA SYSTEM FOR A CONTACTLESS MICROCIRCUIT

(71) Applicant: INSIDE SECURE, Meyreuil (FR)

(72) Inventors: Ghislain BOIRON, Aix en Provence (FR); Jean-Pierre ENGUENT, Aix en Provence (FR); Pierre PIC, Ceyreste (FR)

(21) Appl. No.: 14/759,729

(22) PCT Filed: Jan. 15, 2014
(86) PCT No.: PCT/FR2014/050076

§ 371 Date: Jul. 8, 2015

(30) Foreign Application Priority Data
Jan. 17, 2013 (FR) 1350398

(51) Int. Cl. G06K 19/077

(52) U.S. Cl. CPC G06K 19/07754

(57) ABSTRACT

The present invention relates to a method for manufacturing an object integrating a contactless microcircuit, the method including steps of: forming an antenna coil in the shape of a spiral on a first face of a medium, fixing the microcircuit onto the medium, forming on the medium first and second conducting pads respectively coupled to ends internal and external to the spiral of the antenna coil, connecting the connection terminals of the microcircuit to third and fourth conducting pads, and fixing the microcircuit onto the medium, by arranging opposite one another the first and the third conducting pad, and opposite one another the second and the fourth conducting pad, so as to form two capacitors mounted in series with the antenna coil, the first or second conducting pad including a non-conducting window opposite which the microcircuit is placed.

The present invention relates to microcircuits or contactless integrated circuits, and in particular microcircuits integrated into various objects such as plastic cards (polymer resin), ID documents (ID card, passport, driving license), and objects of which it must be possible to control the origin to prevent counterfeit copies.

Contactless or near field communication NFC microcircuits have been developed to be able to perform transactions with a terminal, by inductive coupling or electric field coupling.

To make a communication by inductive coupling in particular, a sufficient inductive coupling factor must be obtained between an antenna coil of the terminal and an antenna coil connected to the microcircuit. This coupling factor depends on the respective sizes of the antenna coils of the terminal and of the microcircuit, and on the relative distance and positions of these two coils. The more similar the size of the microcircuit coil is to that of the terminal, the higher the coupling factor between the two coils can be.

Generally, antenna coils of terminals have dimensions greater than those of a card in ISO 7816 format. It is thus desirable for the antenna coil of the microcircuit to be as large as possible. However, the larger this coil is in relation to the microcircuit, the more difficult it is to produce a reliable connection between the coil and the microcircuit that is sufficiently strong to withstand frequent handling, and torsions of the medium of the antenna coil.

Contactless microcircuits with their antenna coil are generally produced collectively on a sheet made of polymer resin, generally PVC (polyvinyl chloride), PET (polyethylene terephthalate), or PC (polycarbonate). The sheet is then cut to individualize the antenna circuits. Each antenna circuit and its microcircuit are then integrated into an object such as a smart card, which is generally deformable. It transpires that repeated deformations of the card can lead to the connection between the coil and the microcircuit breaking, which puts the microcircuit permanently out of service.

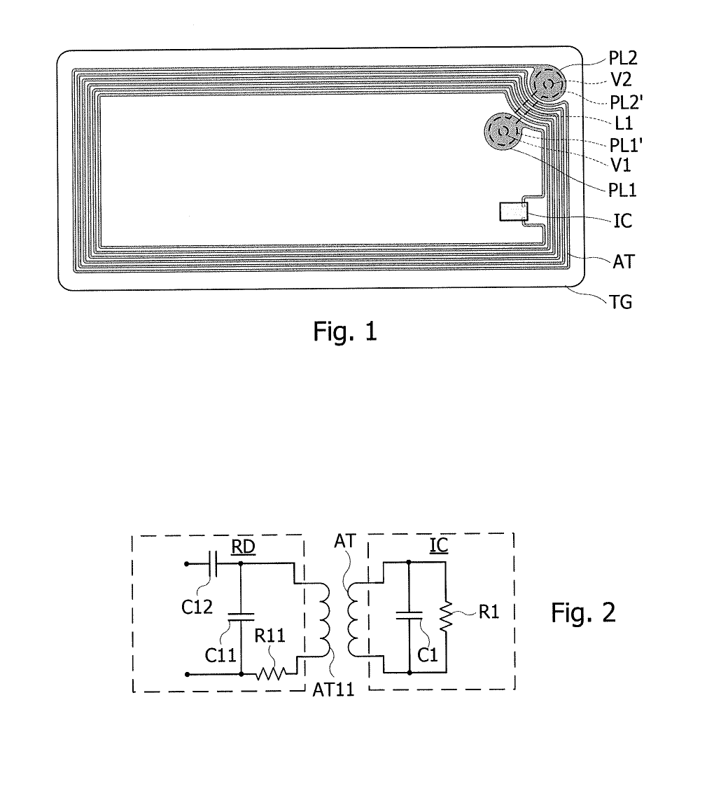

FIG. 1 represents an antenna circuit medium TG associated with a contactless microcircuit IC. The antenna circuit comprises an antenna coil AT formed by a conductor track in the shape of a spiral, on one of the faces of the medium TG. The antenna coil comprises one internal end and one external end. The microcircuit IC that is arranged inside the antenna coil AT, is connected between the internal end of the latter and an interconnection pad PL1. The external end of the antenna coil AT is connected to an interconnection pad PL2. The antenna circuit, including the antenna coil AT and the microcircuit IC, is closed by interconnection pads PL1′, PL2′ and a conducting link L1 coupling the interconnection pads PL1′, PL2′, formed on the other face of the medium. For this purpose, a contact V1 is formed through the medium TG, to couple the pads PL1, PL1′ and a contact V2 is formed through the medium TG to couple the pads PL2, PL2′. The different conducting elements (conductor tracks AT, L1 and conducting pads PL1, PL2) forming the antenna circuit can be produced by etching metal layers, of aluminum for example, deposited on the two faces of the medium TG. The conducting elements can also be produced by depositing copper or an electrically conductive ink (printing) on an insulating medium. Generally, the through contacts V1, V2 are produced by crimping consisting in striking the pads PL1, PL2 so as to crush the medium between the pads PL1 and PL1′ and between the pads PL2 and PL2′, which makes it possible to produce contacts between these pads through the medium.

FIG. 2 is a wiring diagram of the circuit formed on the medium TG by the microcircuit IC and the antenna coil AT, and of a reader RD coupled by induction to the antenna coil AT. The microcircuit IC comprises an internal capacitance symbolized by the capacitor C1 and an internal resistor R1 mounted in parallel with the antenna coil AT. The reader RD comprises an internal resistor R11 mounted in series with an antenna coil AT11, a capacitor C11 mounted in parallel with the coil AT11 and the resistor R11, and a capacitor C12 connected to a terminal common to the capacitor C11 and to the antenna coil AT11.

The dimensions and the number of turns of the antenna coil AT are adjusted so as to set the resonance frequency of the antenna circuit at a value slightly greater than the frequency of the carrier used for wireless communications with the reader RD. Indeed, the resonance frequency of the antenna circuit tends to decrease slightly when it is placed in the field of a reader RD. This resonance frequency FR can be determined by the following equation:

$$FR = \frac{1}{2 π \sqrt{L \cdot C}} \qquad ( 1 )$$

in which L represents the inductance of the antenna circuit i.e. of the antenna coil AT, and C represents the capacitance of the antenna circuit corresponding to the capacitance of the capacitor C1.

It transpires that the formation of through contacts such as the contacts V1, V2 is an additional manufacturing step requiring the implementation of special and costly manufacturing tools specific to a particular circuit geometry. This step significantly increases the time and cost of manufacturing such an antenna circuit.

It is thus desirable to design an antenna circuit for contactless microcircuit not comprising any electrical links passing through the medium of the antenna circuit. It may further be desirable to strengthen the solidity of the electrical links between the microcircuit and the antenna coil formed on the medium. It may further be desirable to protect the antenna circuit against mechanical stress, in particular torsion.

Some embodiments relate to a method for manufacturing an object integrating a contactless microcircuit, the method comprising steps of: forming an antenna coil in the shape of a spiral on a first face of a medium, the antenna coil comprising one end internal to the spiral and one end external to the spiral, providing a contactless microcircuit comprising connection terminals, forming on the medium first and second conducting pads respectively coupled to the internal and external ends of the antenna coil, and coupling the connection terminals of the microcircuit to third and fourth conducting pads, fixing the microcircuit onto the medium by arranging opposite one another the first and the third conducting pad, and opposite one another the second and the fourth conducting pad, the first to fourth conducting pads forming two capacitors mounted in series with the antenna coil. According to one embodiment, the first or second conducting pad comprises a non-conducting window opposite which the microcircuit is placed.

According to one embodiment, the antenna coil and the first and second conducting pads are formed by etching a conducting layer, or by depositing a conducting layer, or by printing an electrically conductive ink, on the first face of the medium.

According to one embodiment, the method comprises steps of forming a fifth conducting pad connected to the internal end of the antenna coil, forming a sixth conducting pad opposite the fifth conducting pad on a second face of the medium and coupling the sixth conducting pad to the first conducting pad.

According to one embodiment, the third and fourth conducting pads are formed on a box into which the microcircuit is integrated.

According to one embodiment, the microcircuit is integrated into a module comprising a medium comprising the third and fourth conducting pads, the third and fourth conducting pads being coupled to the connection terminals of the microcircuit by conducting wires.

Some embodiments also relate to a contactless microcircuit medium, comprising an antenna circuit provided to be coupled to a contactless microcircuit, the antenna circuit comprising an antenna coil in the shape of a spiral on a first face of a medium, the antenna coil comprising one end internal to the spiral and one end external to the spiral, the antenna circuit comprising first and second conducting pads formed on the medium, and respectively coupled to the internal and external ends of the antenna coil, the first and second conducting pads being arranged and shaped to respectively cooperate with third and fourth conducting pads connected to connection terminals of a contactless microcircuit to form two capacitors mounted in series with the antenna coil. According to one embodiment, the first or second conducting pad comprises a non-conducting window opposite which the microcircuit is placed.

According to one embodiment, the antenna coil and the first and second conducting pads are formed in a conducting layer deposited on the first face of the medium.

According to one embodiment, the medium comprises a fifth conducting pad connected to the internal end of the antenna coil, a sixth conducting pad opposite the fifth conducting pad on a second face of the medium, and an electric link between the sixth conducting pad and the third conducting pad.

According to one embodiment, the medium is a card comprising an embossing zone intended to receive inscriptions by deformation of the card, the antenna coil comprising in the embossing zone sections of conductor track that are widened to avoid being cut when embossing the card, the widened sections being pierced with orifices to avoid the propagation of cracks when embossing the card.

Some embodiments also relate to an object integrating a contactless microcircuit, comprising a medium as previously defined, and a microcircuit fixed to the medium and comprising third and fourth conducting pads connected to connection terminals of a contactless microcircuit, the third and fourth conducting pads respectively forming with the first and second conducting pads two capacitors mounted in series with the antenna coil.

According to one embodiment, the microcircuit comprises a double contact and contactless communication interface.

Some examples of embodiments of the present invention will be described below in relation with, but not limited to, the accompanying figures, in which:

FIG. 1 described above schematically represents one face of an antenna circuit medium coupled to a contactless microcircuit,

FIG. 2 described above is a wiring diagram of the microcircuit and of the antenna coil in FIG. 1, and of an antenna circuit of a reader coupled to the antenna of the microcircuit,

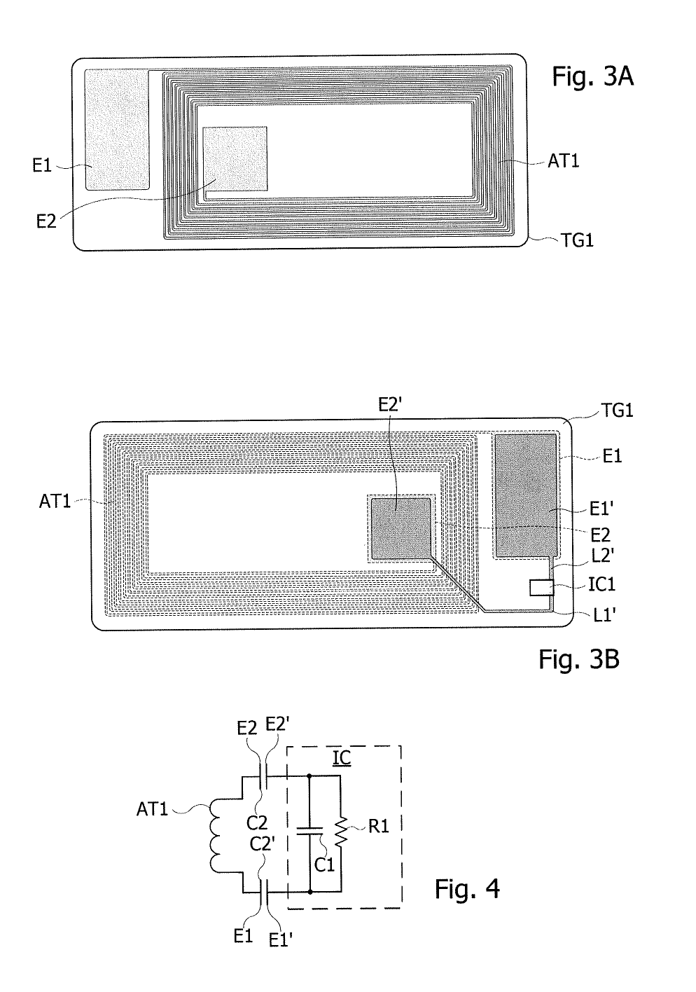

FIGS. 3A and 3B schematically represent the two faces of an antenna circuit medium coupled to a contactless microcircuit, according to one embodiment,

FIG. 4 is a wiring diagram of the microcircuit and of the antenna circuit represented on FIGS. 3A, 3B,

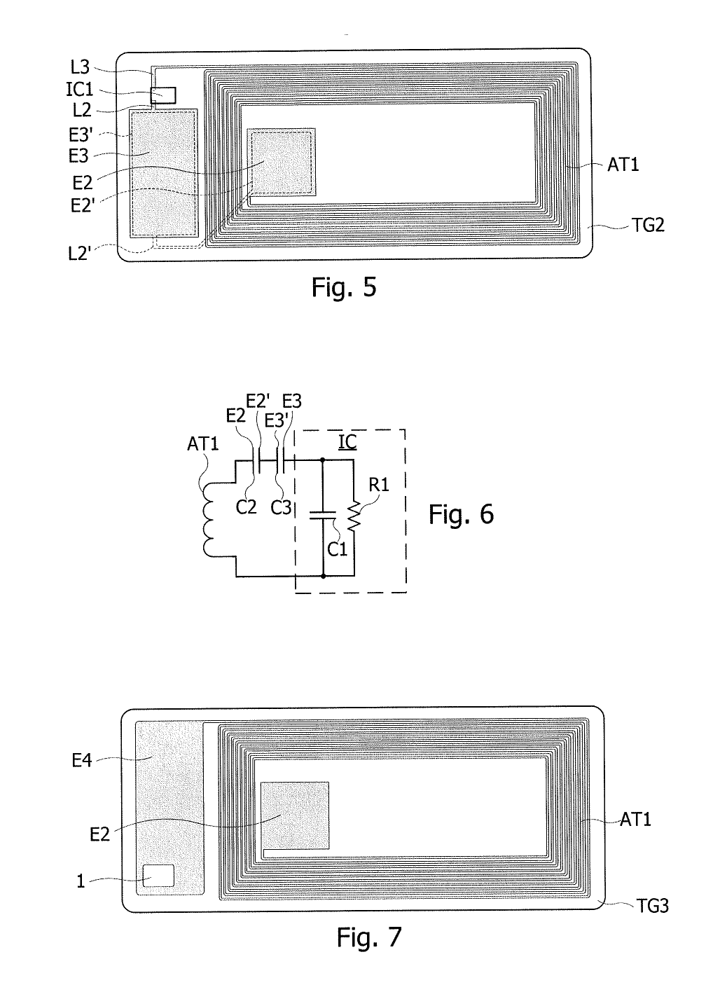

FIG. 5 schematically represents one face of an antenna circuit medium coupled to a contactless microcircuit, according to another embodiment,

FIG. 6 is a wiring diagram of the microcircuit and of the antenna circuit represented on FIG. 5,

FIG. 7 schematically represents one face of an antenna circuit medium coupled to a contactless microcircuit, according to another embodiment,

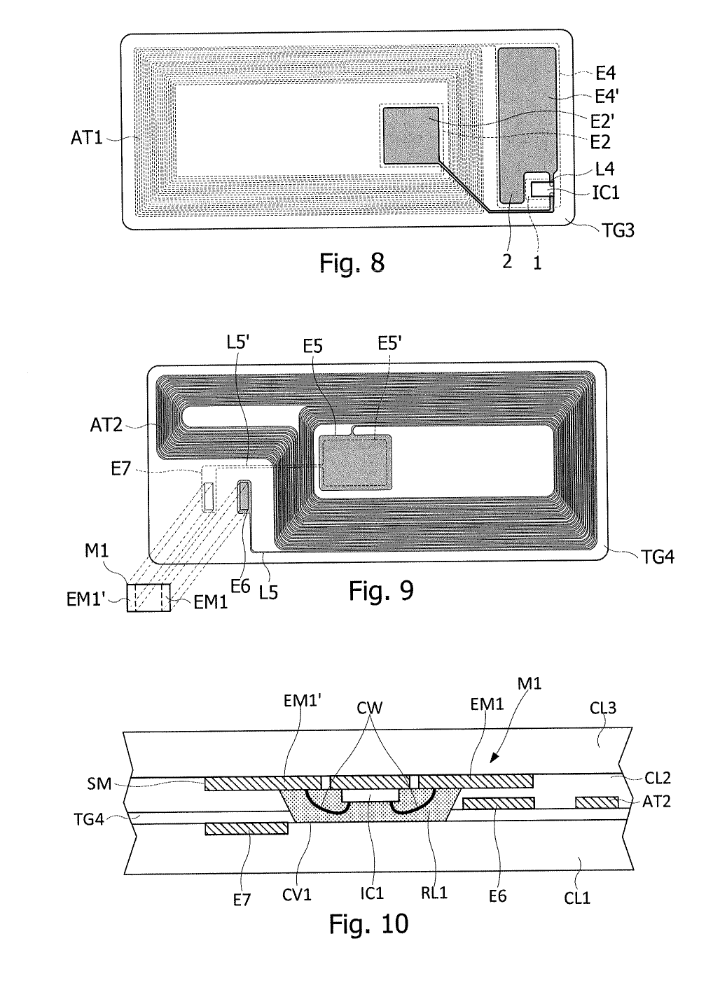

FIG. 8 schematically represents the other face of the medium in FIG. 7,

FIG. 9 schematically represents one face of an antenna circuit medium coupled to a contactless microcircuit, according to another embodiment,

FIG. 10 is a schematic cross-section of the medium in FIG. 9, implanted in a card,

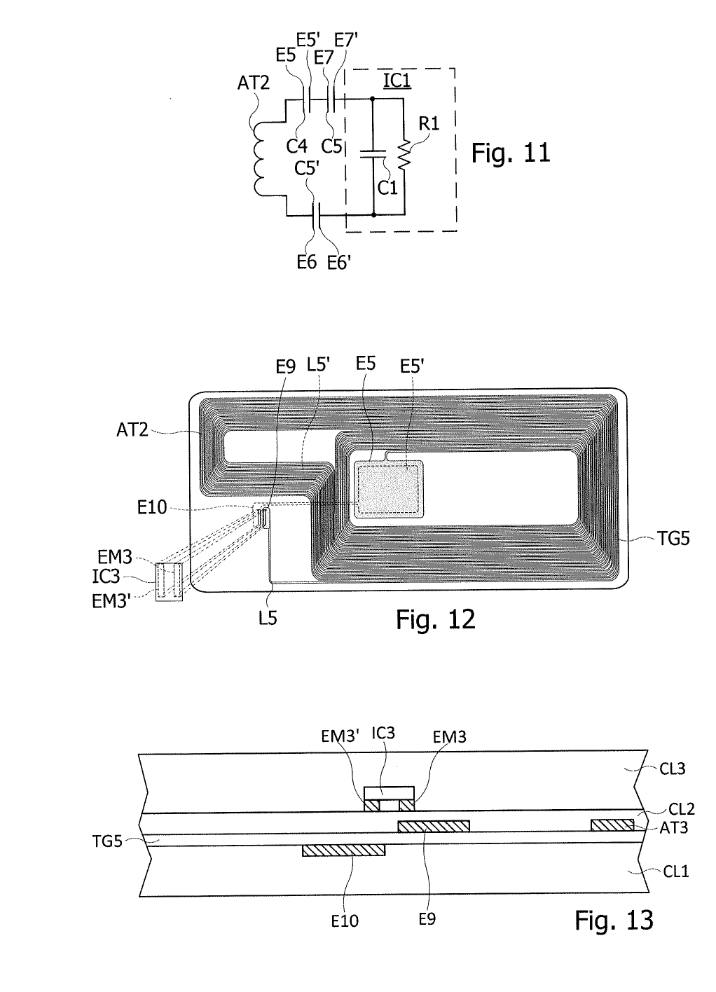

FIG. 11 is a wiring diagram of the microcircuit and of the antenna circuit represented on FIG. 9,

FIG. 12 schematically represents one face of a contactless microcircuit card, according to another embodiment,

FIG. 13 is a schematic cross-section of the microcircuit card in FIG. 12,

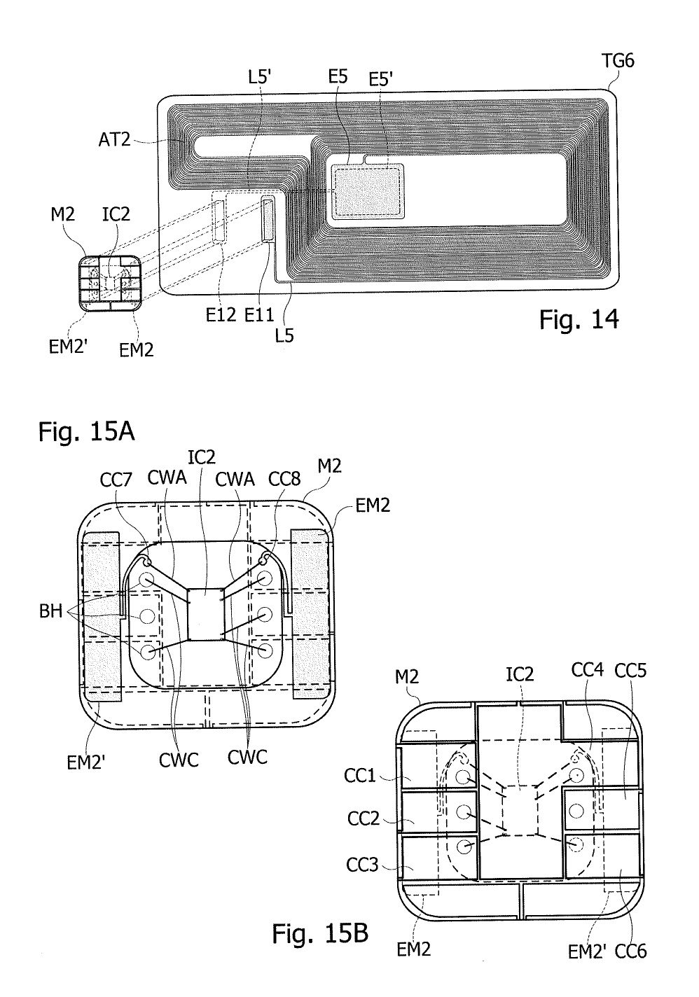

FIG. 14 schematically represents one face of a microcircuit card with a double contact and contactless interface, according to another embodiment,

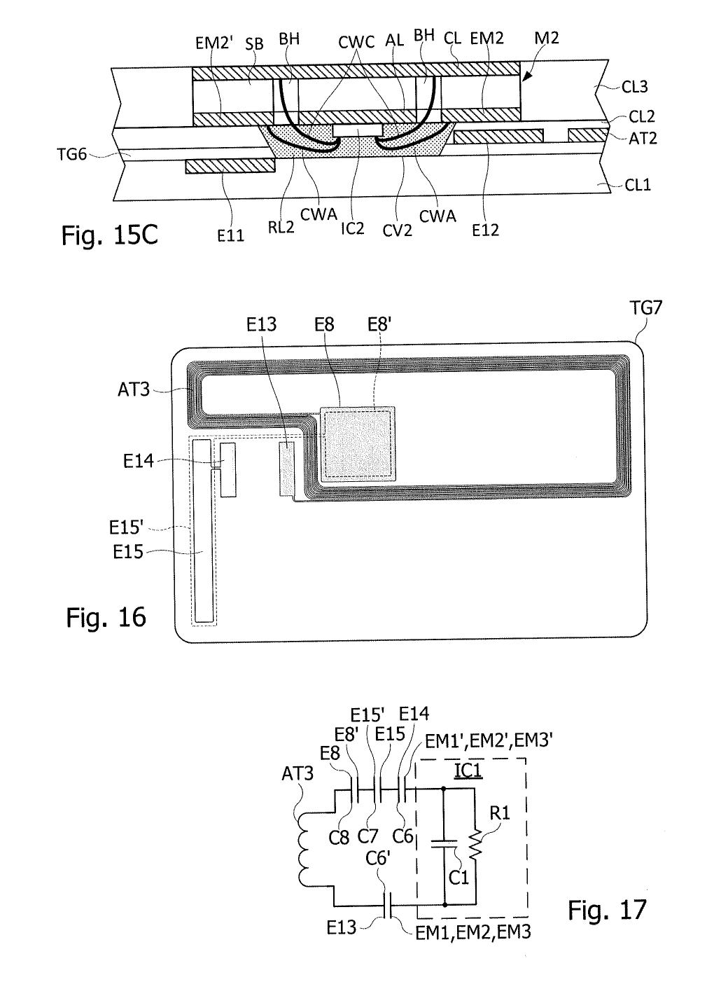

FIGS. 15A, 15B schematically represent two faces of a module integrating the microcircuit in FIG. 14, the module being implanted into the card in FIG. 14,

FIG. 15C is a schematic cross-section of the card in FIG. 14,

FIG. 16 schematically represents one face of a contactless microcircuit card, according to another embodiment,

FIG. 17 is a wiring diagram of the antenna circuit represented in FIG. 16, coupled to a microcircuit,

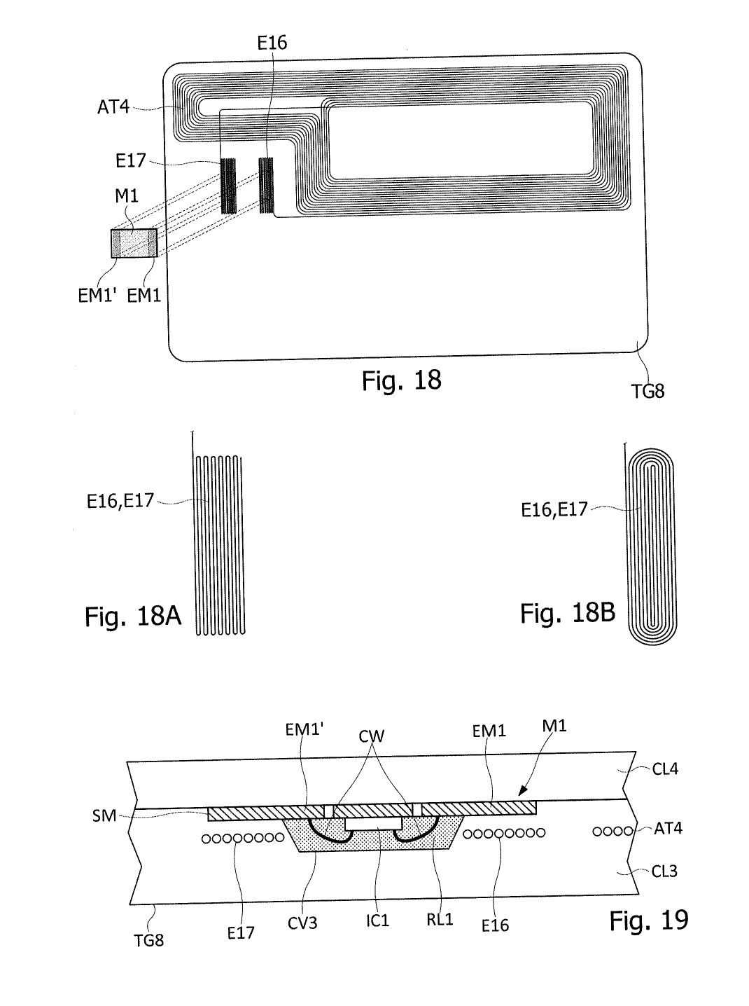

FIG. 18 schematically represents one face of a contactless microcircuit card, according to another embodiment,

FIGS. 18A, 18B represent a detail of FIG. 18, according to two embodiments,

FIG. 19 is a schematic cross-section of the microcircuit card in FIG. 18,

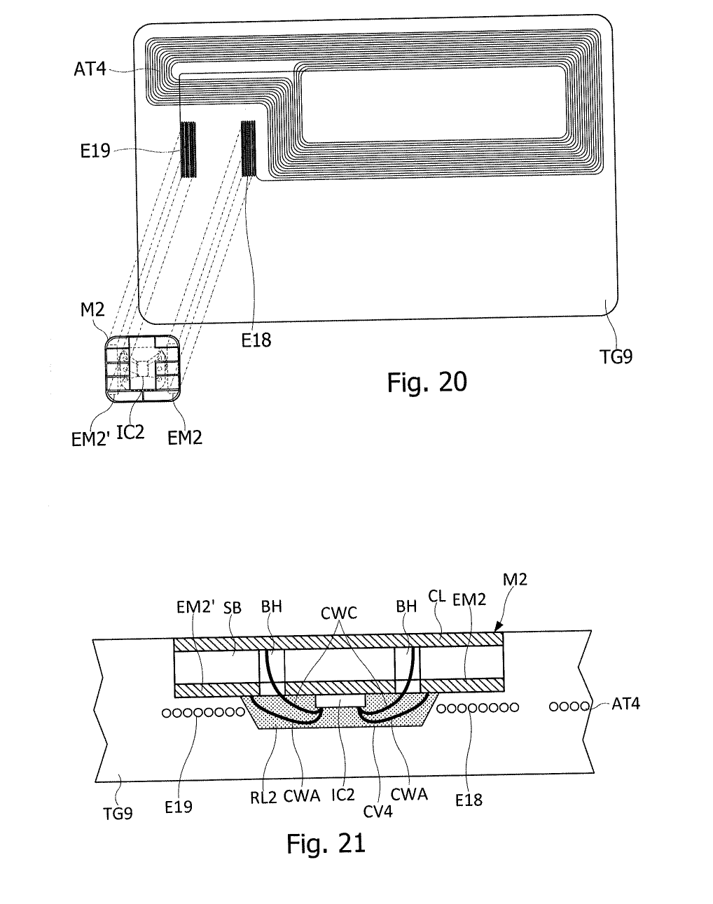

FIG. 20 schematically represents one face of a microcircuit card with a double contact and contactless interface, according to another embodiment,

FIG. 21 is a schematic cross-section of the microcircuit card in FIG. 20,

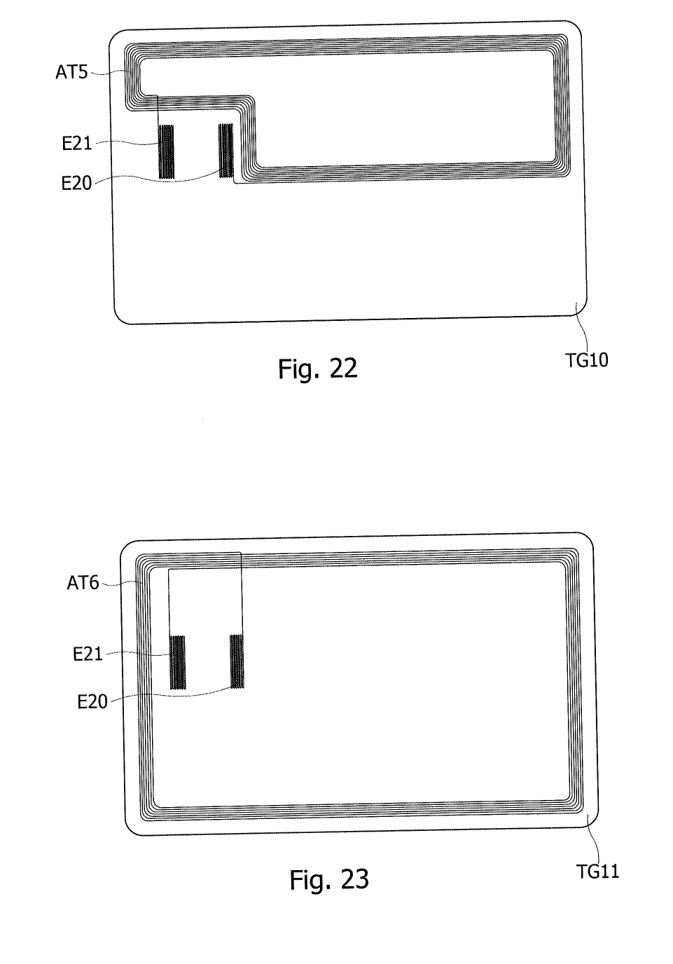

FIGS. 22 to 24 each schematically represent one face of a contactless microcircuit card, according to other embodiments,

FIG. 25 schematically represents one face of an antenna circuit medium coupled to a contactless microcircuit, according to another embodiment.

FIGS. 3A and 3B represent the two faces of an antenna circuit medium TG1, onto which a contactless microcircuit is fixed, according to one embodiment. FIG. 3A represents one face of the medium TG1 comprising an antenna coil AT1 formed by a conductor track in a spiral. The antenna coil comprises one external end and one internal end. The external end is coupled by a conductor track to a relatively large pad forming a capacitor electrode E1. The internal end is coupled by a conductor track to a relatively large pad forming a capacitor electrode E2.

FIG. 3B represents the other face of the medium TG1, the antenna coil AT1 and the electrodes E1 and E2 being shown in dotted lines. The other face of the medium TG1 comprises a pad E1′ forming a capacitor electrode. The electrode E1′ has substantially the dimensions of the electrode E1 and is formed substantially opposite the latter. In practice, one of the two pads E1, E1′ may be larger than the other to take account of manufacturing tolerances, particularly concerning the positioning of the pads E1, E1′ on the surface of the medium. The other face of the medium TG1 also comprises a pad E2′ forming a capacitor electrode. The pad E2′ has substantially the dimensions of the electrode E2 and is formed substantially opposite the latter. The electrode E1′ is coupled to a connection terminal of a microcircuit IC1 by a conductor track L2′. The electrode E2′ is coupled to a connection terminal of a microcircuit IC1 by a conductor track L1′.

The medium TG1 is made in a sheet of a dielectric material such as PET, and has a thickness lower than 50 μm, for example between 35 and 40 μm to be able to be inserted into an object such as an ID card or a tag. The microcircuit IC1 may have a thickness between 50 and 300 μm, for example equal to 150 μm to within 10%. The medium TG1 may have various dimensions depending on the targeted application, for example 56×26 mm, or 89×125 mm, or even 25×25 mm, these values being defined to within 10%.

FIG. 4 represents the electric circuit comprising the antenna circuit formed on the medium TG1 with the microcircuit IC1. The antenna circuit comprises the capacitor C1 and the resistor R1 of the microcircuit IC1, mounted in parallel. One of the terminals of the capacitor C1 and of the resistor R1 is connected to a capacitor C2 formed by the electrodes E1, E1′. The other terminal of the capacitor C1 and of the resistor R1 is connected to a capacitor C2′ formed by the electrodes E2, E2′. The capacitors C2, C2′ are interconnected by the antenna coil AT1. The capacitance C of the antenna circuit to be taken into account for the calculation of the resonance frequency of the antenna circuit (equation (1)) is the equivalent capacitance of the three capacitors C1, C2, C2′ mounted in series. The inductance of the antenna circuit is that of the antenna coil AT1.

It transpires that adding capacitors in series in the antenna circuit improves the quality factor of the circuit. Indeed, it can be shown that:

$$\frac{Q}{{Q}_{0}} = 1 + \frac{C 1}{C r} \qquad ( 2 )$$

where Q₀ is the quality factor of the antenna circuit of the microcircuit in FIG. 2, Cr is the equivalent capacitance of the antenna circuit outside the microcircuit IC1, and C1 is the internal capacitance of the microcircuit IC1. As the equivalent capacitance Cr is generally lower than the capacitance C1 of the microcircuit, the quality factor gain Q/Q₀ can reach several units, or even several tens of units. In addition, the lower the capacitance Cr is, the higher the quality factor Q. However, a decrease in the capacitance Cr results in an increase in the resonance frequency FR (cf. (1)) of the circuit. This capacitance decrease can be offset by an increase in the inductance of the antenna coil, by increasing the number of turns of the antenna coil.

FIG. 5 represents one face of an antenna circuit medium TG2, according to another embodiment. Conducting pads and conductor tracks formed on the other face of the medium TG2 are represented in dotted lines. The medium TG2 differs from the medium TG1 in that the microcircuit is arranged on the same side of the medium as the antenna coil AT1. Thus, the external end of the antenna coil AT1 is coupled to the microcircuit IC1 by a conductor track L3. Another terminal of the microcircuit IC1 is coupled to a conducting pad E3 through a conductor track L2. The internal end of the antenna coil AT1 is connected to the conducting pad E2. On the other face of the medium TG2, the conducting pad E2′ is formed opposite the conducting pad E2, and a conducting pad E3′ is formed opposite the conducting pad E3. The pads E2 and E3 are coupled by the conductor track L2′.

FIG. 6 represents the electric circuit formed on the medium TG2 with the microcircuit IC1. This circuit differs from the one represented in FIG. 4 in that the capacitor C2′ in FIG. 4 is removed and in that a capacitor C3 is mounted in series between the microcircuit IC1 and the capacitor C2. The capacitor C3 is formed by the conducting pads E3, E3′. The dimensions of the parts opposite the conducting pads E3, E3′ may be substantially identical to those of the conducting pads E1, E1′.

FIG. 7 represents one face of an antenna circuit medium TG3, according to another embodiment. The represented face of the medium TG3 comprises the antenna coil AT1 and the conducting pad E2 connected to the internal end of the spiral forming the antenna coil AT1. The external end of the antenna coil AT1 is coupled to a conducting pad E4 of a substantially rectangular shape having a non-conducting window 1 of a substantially rectangular shape.

FIG. 8 represents the other face of the medium TG3, the conducting elements formed on the face represented in FIG. 7 being drawn in dotted lines. The face of the medium TG3, represented in FIG. 8, comprises the conducting pad E2′ coupled by the conductor track L2′ to a connection terminal of the microcircuit IC1 that is arranged opposite the window 1 on the other face of the medium TG3. Another terminal of the microcircuit IC1 is coupled to a conducting pad E4′ by a conductor track L4. The pad E4′ has a main part of a substantially rectangular shape and an extension 2 also of a substantially rectangular shape. The main part of the pad E4′ covers the pad E4 except for a zone including the window 1. The extension 2 of the pad E4′ covers a zone of the pad E4, between the window 1 and two adjacent edges of the pad E4. The conducting pads E4, E4′ enable the microcircuit IC1 and its connections to be mechanically reinforced, and form a barrier against the propagation of cracks in the medium TG3. Indeed, the hardness differential formed between, on the one hand, the metal layer in which the pad E4 is formed, and, on the other hand, the medium TG3 (which may be made of PVC, PC, PET, printed circuit wafer, paper, Teslin®, etc.), prevents the propagation of cracks that may form from the edge of the medium. The window 1 also enables the surface area of electrodes to be increased by using for this purpose the surface of the microcircuit IC1 and facilitates the placement of the microcircuit on the medium TG3, which is generally performed using a video camera, when manufacturing the product.

FIG. 9 represents one face of an antenna circuit medium TG4, according to another embodiment. The represented face of the medium TG4 comprises an antenna coil AT2 in the shape of a spiral and a conducting pad E5 connected to the internal end of the spiral forming the antenna coil AT2. The external end of the antenna coil AT2 is coupled to a conducting pad E6 of a substantially rectangular shape by a conductor track L5. The other face of the medium TG4 comprises conducting elements drawn in dotted lines on FIG. 9. These conducting elements comprise a conducting pad E5′ coupled by a conductor track L5′ to another conducting pad E7. The pad E5′ is formed opposite the pad E5 and has substantially the same shape and the same dimensions as the latter. The conducting pads E6, E7 are provided to be capacitively coupled to conducting pads EM1, EM1′ formed on a module M1 integrating the microcircuit IC1. The module M1 is represented separated from the medium TG4 for greater clarity. The conducting pads E6 and EM1 form a capacitor, and the pads E7, EM1′ form another capacitor, such that the module M1 is capacitively coupled to the antenna circuit formed on the medium TG4. The coil AT2 comprises internal turns of a substantially rectangular shape, and external turns comprising a main part of a substantially rectangular shape with an extension of a substantially rectangular shape extending between two adjacent edges of the medium TG4 and the pads E6, E7.

FIG. 10 represents a cross-section along a plane passing through the electrodes EM1 and EM1′, of the module M1 and the medium TG4, implanted in a card made for example of PVC, which can have dimensions compliant with the ISO 7810 standard. The module M1 comprises the contactless microcircuit IC1 stuck onto a rear face of a metal medium SM (also referred to as “leadframe”) and connected by wires CW to the medium SM. The microcircuit and the wires CW are encapsulated in a resin RL1 ensuring their mechanical protection. The layer RL1 may extend only over a central zone of the rear face of the medium SM. The medium SM is then cut from its front face, to form the contact pads EM1, EM1′ of the module M1 to which the wires CW are coupled. The medium TG4, with the pads E6, E7 and the antenna coil AT2, is fixed between two layers CL1, CL2. The module M1 is inserted into a cavity CV1 formed in the layer CL2 and the medium TG4, so that the pads EM1, EM1′ of the module M1 are respectively opposite the pads E6, E7 formed on the medium TG4. A layer CL3 is arranged on the layer CL2 and on the module M1. The layers CL1, CL2, CL3 are for example made of PVC.

This thus avoids having to connect terminals of the module M1 to conducting pads formed on the medium. Thus, the microcircuit medium TG4 can be subjected to higher torsions than those usually tolerated by assemblies comprising electrical connections, without any risk of breaking the links between the module M1 and the antenna circuit formed on the medium TG4.

In the example in FIG. 9, the antenna coil AT2 follows the contours of the medium except for a rectangle in the bottom left-hand corner of the medium, in which the pads E6, E7 and the microcircuit IC1 are arranged. A certain number of central turns of the antenna coil have a substantially rectangular shape.

FIG. 11 represents the electric circuit formed on the medium TG4 connected to the module M1 integrating the microcircuit IC1. The microcircuit IC1 is coupled to the antenna coil AT2 on one side through capacitors C4, C5 connected in series, and on the other side by a capacitor C4′. The capacitor C4 is formed by the conducting pads E5, E5′. The capacitor C5 is formed by the conducting pads E7, EM1. The capacitor C5′ is formed by the conducting pads E6, EM1.

It shall be noted that the surface areas of the conducting pads EM1, EM1′ are relatively small. The result is that the capacitance of the capacitors C5, C5′ is low. The capacitors C5, C5′ and C4 may have capacitances respectively of 7 pF, 11 pF and 100 pF, whereas the capacitance of the capacitor C1 may be in the order of 90 pF. The result is that the equivalent capacitance of the capacitors C4, C5, C5′ is in the order of 4 pF. Given the equation (2), the quality factor ratio Q/Q₀ can theoretically reach 23.5.

FIG. 12 represents one face of an antenna circuit medium TG5, according to another embodiment. The medium TG5 differs from the medium TG4 in that a microcircuit IC3 is directly fixed onto the medium TG5, i.e. without previously being integrated into the module M1. For greater clarity, the microcircuit IC3 is represented on FIG. 12, enlarged and separated from the medium TG5. The pads E6 and E7 formed on the medium TG4 are replaced on the medium TG5 with smaller conducting pads E9, E10 closer to one another.

FIG. 13 represents a cross-section of the medium TG5 and the microcircuit IC3, implanted in a card for example made of PVC, which may have dimensions compliant with the ISO 7810 standard. The medium TG5 with the pads E9, E10 and the antenna coil AT2, is fixed between two layers CL1, CL2. The microcircuit IC3 differs from the microcircuit IC1 in that it comprises relatively large contact pads EM3, EM3′, also referred to as “mega bumps”, that are connected to connection terminals of the microcircuit. The microcircuit IC3 is arranged on the layer CL2, so that the pads EM3, EM3′ are opposite the pads E9, E10. A protective layer CL3 is arranged on the layer CL2 and the microcircuit IC1. The layers CL1, CL2, CL3 are for example made of PVC. Thus, the conducting pads E9, E10 are capacitively coupled to the conducting pads EM3, EM3′ formed on the microcircuit IC3. The wiring diagram of the antenna circuit thus formed is substantially the same as the one presented on FIG. 11, to within the values of the capacitors C5, C5′.

The capacitors formed by the conducting pads E9, EM3 and E10, EM3′ may have capacitances in the order of 3 and 2 pF, which gives an equivalent capacitance of the antenna circuit outside the microcircuit IC3 of the order of 1 pF. With an internal microcircuit capacitance C1 of the order of 90 pF, the quality factor ratio Q/Q₀ can theoretically reach 91.

FIG. 14 represents one face of an antenna circuit medium TG6, according to another embodiment. The medium TG6 differs from the medium TG4 in that it is associated with a module M2 with a double contact and contactless interface, the contacts being for example compliant with the ISO 7816 standard. Thus, the medium TG6 comprises the antenna coil AT2 and the conducting pads E5, E5′. The conducting pads E6 and E7 are replaced with conducting pads E11, E12 adapted to the geometry of the module M2 and in particular to the geometry of conducting pads EM2, EM2′ formed on the module M2. The module M2 comprises an integrated circuit IC2 comprising a contactless interface connected to the pads EM2, EM2′ and a contact interface connected to contact pads.

FIGS. 15A and 15B are respectively views of the rear and front faces of the module M2. FIG. 15C is a cross-section of the module M2 once implanted in a cavity CV2 formed in a card for example in the format conforming to the ISO 7816 standard. The module M2 comprises a wafer comprising an electrically insulating substrate SB, the front and rear faces of which are covered with electrically conductive etched layers CL, AL. On FIG. 15A, the microcircuit IC2 is fixed onto the back of the wafer SB, i.e. onto the layer AL, or in a cavity formed in the layer AL and possibly in the layer SB. The contact interface of the microcircuit IC2 is coupled to contact pads CC1, CC2, CC3, CC4, CC5, CC6, formed in the layer CL, through wires CWC connected on one side to the microcircuit and passing in holes BH through the substrate SB to reach the contact pads CC1-CC6 formed in the layer CL. The contactless interface of the microcircuit IC2 is coupled to contact pads CC7, CC8 formed in the layer AL, through wires CWA. The pads CC7, CC8 are coupled by conductor tracks to the pads EM2, EM2′, also formed in the layer AL. The assembly consisting of the microcircuit IC2 and the wires CWC, CWA is embedded in a layer of resin RL2 mechanically protecting them. In one alternative embodiment, the layer RL2 may extend only over a central zone of the rear face of the layer AL. On FIG. 15B, the contact pads CC1-CC6 have for example the shape specified by the ISO 7816 standard.

On FIG. 15C, the medium TG6, with the pads E11, E12 and the antenna coil AT2, is fixed between two layers CL1, CL2. The module M2 is inserted into a cavity CV2 that is formed in the layer CL2 and the medium TG5 at the location of the module M2, so that the pads EM2, EM2′ of the module M2 are respectively opposite the pads E11, E12 formed on the medium TG6. A layer CL3 is arranged on the layer CL2 while leaving the contact pads CC1-CC6 apparent. The layers CL1, CL2, CL3 are for example made of PVC.

Other capacitors may be formed on the medium of the antenna circuit, particularly to adapt the resonance frequency of the antenna circuit to the frequency of the data transmission carrier emitted by a reader RD of the microcircuit IC1, IC2 or IC3. It can also be provided to add conducting pads so that the pads EM1′ and E11 are at the same distance from an opposite conducting pad, which enables a higher equivalent capacitance to be obtained for the antenna circuit.

FIG. 16 represents a microcircuit card TG7 for example in the ISO 7816 format. The card TG7 comprises on one face an antenna coil AT3 in the shape of a spiral with one internal end coupled to a conducting pad E8, and one external end coupled to a conducting pad E13. The face of the card TG7 where the coil AT3 is formed also comprises two interconnected conducting pads E14 and E15. The other face of the card TG7 comprises two interconnected conducting pads E8′ and E15′ (represented in dotted lines), the pad E8′ being arranged opposite the pad E8 and the pad E15′ opposite the pad E15. The pads E13 and E14 are provided to be capacitively coupled with the pads EM1, EM1′ of the module M1, the pads EM2, EM2′ of the module M2, or the pads EM3, EM3′ of the microcircuit IC3. According to one alternative embodiment, the pads E15, E15′ can be formed near an edge of the card TG7 outside a zone of the card, intended to receive inscriptions by embossing.

FIG. 17 represents the electric circuit formed on the card TG7 connected to the microcircuit IC1 (or IC2, or IC3). The microcircuit IC1 (or IC2, or IC3) is coupled to the antenna coil AT2, on one side through capacitors C6, C7, C8 connected in series, and on the other side by a capacitor C6′. The capacitor C6 is formed by the conducting pad E14 with the pad EM1′, EM2′ or EM3′. The capacitor C7 is formed by the conducting pads E15, E15′. The capacitor C8 is formed by the conducting pads E8, E8′. The capacitor C6′ is formed by the conducting pad E13 with the pad EM1, EM2 or EM3.

In the embodiments described above, the antenna coil AT1, AT2 and the conducting pads formed on the media T1 to TG6 may be produced by etching electrically conductive layers, by depositing metal or by electrically conductive ink printing. In the case of production by etching, the conducting layers are for example made of aluminum. In other embodiments shown by FIGS. 18 to 23, the antenna coil is produced using an electrically conductive wire, for example made of copper, insulated in a sheath or by means of a varnish. The conducting wire is gradually pushed into a card for example made of PVC using ultrasounds capable of locally melting the card. The insulated wire is thus unwound following the route of the turns of the antenna coil. The wire may have a diameter of 30 μm to 3 mm. The spacing pitch between the turns may be twice the thickness of the insulating material covering the wire, i.e. approximately 20 μm. Using such an insulated conducting wire avoids having to produce a capacitive coupling between the two faces of the medium of the antenna coil.

FIG. 18 represents a card TG8 for example in the ISO 7816 format, comprising an antenna coil AT4 formed by a conducting wire embedded in the plastic forming the card. The antenna coil AT4 has a shape substantially identical to that of the coil AT2. The ends of the spiral forming the coil AT4 are coupled to zones E16, E17 where the wire forming the coil AT4 is wound around itself (FIG. 18B) or tightly arranged in zigzag (FIG. 18A), so as to form a capacitor electrode. The electrodes E16, E17 cooperate with the conducting pads EM1, EM1′ of the module M1 to form two capacitors. On FIG. 19, the module M1 is inserted into a cavity CV3 that is formed in a layer CL4 of the card TG8 at the location of the module M1, so that the pads EM1, EM1′ of the module M1 are respectively opposite the electrodes E16, E17 implanted in the layer CL4 of the card TG8. The card TG8 may comprise a layer CL5 that is arranged on the layer CL4 and the module M1. The layers CL4, CL5 are for example made of PVC.

FIG. 20 represents a card TG9 for example in the ISO 7816 format. The card TG9 differs from the card TG8 in that the module M1 is replaced with the module M2. The electrodes E16, E17 are thus replaced with electrodes E18, E19 adapted to the dimensions of the pads EM2, EM2′ of the module M2. The electrodes E18, E19 are also formed by the wire forming the coil AT4, wound around itself or tightly arranged in zigzag, in the manner represented in FIG. 18A or 18B.

FIG. 21 represents a cross-section of the module M2 and a part of the card TG9. The module M2 is inserted into a cavity CV4 that is formed in the card TG9 at the location of the module M2, so that the pads EM2, EM2′ of the module M2 are respectively opposite the electrodes E18, E19 implanted in the card TG9. The cavity CV4 has a depth such that the contacts CC1-CC6 of the module M2 are flush with the surface of the card TG9 that can be formed in one or more layers.

FIG. 22 represents a card TG10 comprising an antenna coil AT5 which differs from the coil AT4 in that it does not comprise the central turns of rectangular shape of the coil AT4. The ends of the coil AT5 are coupled to electrodes E20, E21 (formed in the manner shown in FIG. 18A or 18B) that are adapted to the pads EM1, EM1′ of the module M1, or to the pads EM2, EM2′ of the module M2, to be implanted into the card TG10, or even to the pads EM3, EM3′ of the microcircuit IC3.

In the embodiments of FIGS. 18, 20 and 22, the antenna coil AT4, AT5 substantially extends over a half of the card, the other half being intended to receive inscriptions formed by deforming or embossing the card. In the embodiment shown by FIG. 23, the card TG11 comprises an antenna coil AT6 which differs from the antenna coil AT5 in that the turns of the antenna coil follow all the edges of the card TG11, passing in particular between an embossing zone and one edge of the card adjacent to this zone. The ends of the coil AT6 are coupled to the electrodes E20, E21 that are adapted to the pads EM1, EM1′ of the module M1, or to the pads EM2, EM2′ of the module M2, or even to the pads EM3, EM3′ of the microcircuit IC3, to be implanted into the card TG11.

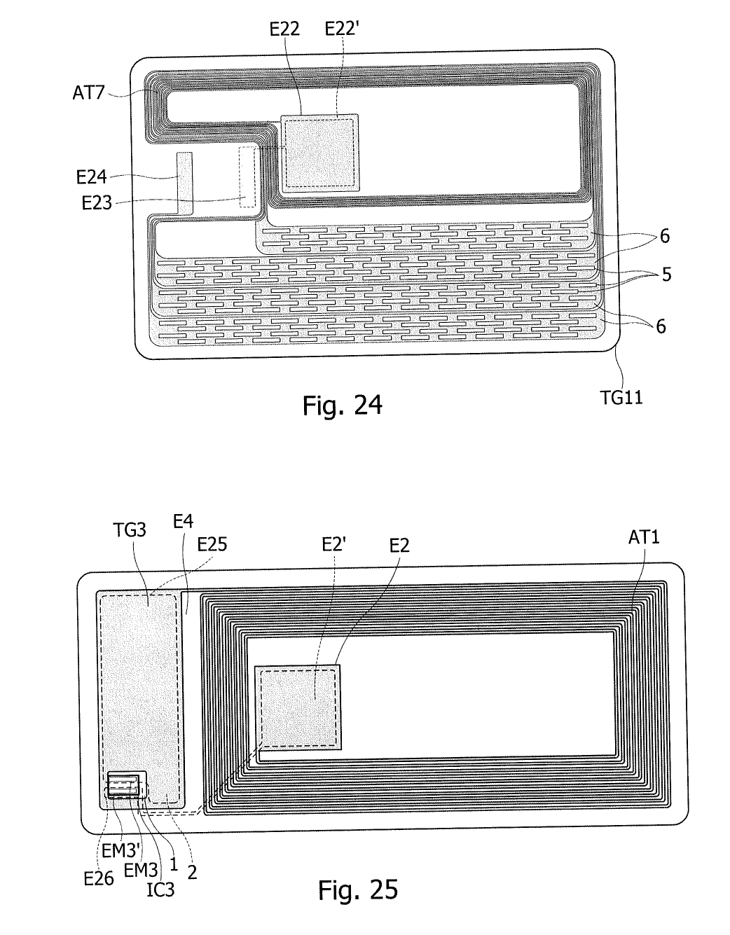

According to one embodiment, the embossing zone of the card is also covered with widened parts of turns of the antenna coil. Thus, FIG. 24 represents a card TG11 comprising an antenna coil AT7 formed by etching a metallized layer deposited on a substrate. The coil AT7 comprises one internal end coupled to a conducting pad E22, and one external end coupled to a conducting pad E23. The other face of the card comprises conducting pads E22′, E23 coupled to one another, the pad E22′ being arranged opposite the pad E22. The dimensions and the arrangement of the pads E23, E24 on the card are adapted to the dimensions of the pads EM1, EM2, EM2′, EM3, EM3′ of the module M1, M2 or of the microcircuit IC3, to be implanted into the card TG11, and to the location of the latter on the card. Each of the external turns of the coil AT7 comprises in the embossing zone of the card TG11 a part 6 that has a width greater than the width of the turn outside the embossing zone. The width of the part 6 of each external turn is defined so that the turn is not cut when embossing the card TG11. The part 6 of each external turn may comprise orifices 5 for example of rectangular shape preventing the propagation of any cracks that may appear when embossing the card TG11. The most external turn of the coil AT7 is connected to the pad E24. The internal turns without any widened part 6 of the coil AT7 and a first of the external turns comprising a widened part 6, have a substantially rectangular shape with a rectangular extension between two adjacent edges of the card and the pads E23, E24. The external turns comprising the part 6, except the internal turn of these turns, follow the edges of the card except for a part of the card comprising the pads E23, E24, where the turns bypass these pads.

According to one embodiment, the antenna circuit comprising the antenna coil AT1-AT7 coupled to capacitor electrodes, is collectively manufactured with other antenna circuits on a sheet or a plate made of polymer resin (PVC, PC, PET, printed circuit wafer, paper, Teslin®). Microcircuits such as the microcircuit IC1 or IC3, or modules M1, M2 are then fixed onto each sheet or plate. The sheet or plate is then cut to individualize the antenna circuits formed on the sheet or plate. Each antenna circuit thus individualized can then be implanted into an object such as a tag or a card in the ISO 7816 format. The modules M1, M2 may also be collectively manufactured on a plate, that is finally cut to individualize the modules.

It will be understood by those skilled in the art that the present invention is susceptible of various alternative embodiments and various applications. In particular, the invention is not limited to the embodiments previously described, but also extends to the possible combinations of these embodiments. Thus, the connections of the microcircuit IC1 with the antenna circuit on FIGS. 3A, 3B, 5, 7 and 8 may be performed by capacitive coupling as presented in FIG. 9 and following. In particular, the embodiment presented by FIGS. 7 and 8 may be combined with the one presented on FIG. 12, so as to benefit from the presence of the window 1 to facilitate the positioning of the microcircuit by video camera, on the medium TG5. FIG. 25 represents an antenna circuit medium TG12 comprising the antenna coil AT1 and the conducting pads E2, E2′ and E4 of the medium TG3. The medium TG12 also comprises a conducting pad E25′ (replacing the pad E4′) formed opposite the pad E4, as well as a pad E26 formed opposite the window 1 coupled to the pad E2′. The pad E25 comprises a part extending opposite the window 1. The microcircuit IC3 with the pads EM3 and EM3′ is placed in the window 1 (on the face of the medium TG12 where the pad E4 is formed), so that the pad EM3 is arranged opposite the part of the pad E25 situated opposite the window 1, and the pad EM3′ is arranged opposite the pad E26. It shall be noted that the pad E25 forms two capacitors with the pads E4 and EM3.

1. A method for manufacturing an object integrating a contactless microcircuit, the method comprising steps of:
forming an antenna coil in the shape of a spiral on a first face of a medium, the antenna coil comprising one end internal to the spiral and one end external to the spiral,
providing a contactless microcircuit comprising connection terminals,
forming on the medium first and second conducting pads respectively coupled to the internal and external ends of the antenna coil, and
coupling the connection terminals of the microcircuit to third and fourth conducting pads,
fixing the microcircuit onto the medium by arranging opposite one another the first and the third conducting pad, and opposite one another the second and the fourth conducting pad, the first to fourth conducting pads forming two capacitors mounted in series with the antenna coil,
wherein the first or second conducting pad comprises a non-conducting window opposite which the microcircuit is placed.

2. Method according to claim 1, wherein the antenna coil and the first and second conducting pads are formed by etching a conducting layer, or by depositing a conducting layer, or by printing an electrically conductive ink, on the first face medium.

3. Method according to claim 1, comprising steps of forming a fifth conducting pad connected to the internal end of the antenna coil, forming a sixth conducting pad opposite the fifth conducting pad on a second face of the medium and coupling the sixth conducting pad to the first conducting pad.

4. Method according to claim 1, wherein the third and fourth conducting pads are formed on a box into which the microcircuit is integrated.

5. Method according to claim 1, wherein the microcircuit is integrated into a module comprising a medium comprising the third and fourth conducting pads, the third and fourth conducting pads being coupled to the connection terminals of the microcircuit by conducting wires.

6. A contactless microcircuit medium, comprising an antenna circuit provided to be coupled to a contactless microcircuit, the antenna circuit comprising an antenna coil in the shape of a spiral on a first face of a medium, the antenna coil comprising one end internal to the spiral and one end external to the spiral, and first and second conducting pads formed on the medium, and respectively coupled to the internal and external ends of the antenna coil, the first and second conducting pads being arranged and shaped to respectively cooperate with third and fourth conducting pads connected to connection terminals of a contactless microcircuit to form two capacitors mounted in series with the antenna coil,
wherein the first or second conducting pad comprises a non-conducting window opposite which the microcircuit is placed.

7. Medium according to claim 6, wherein the antenna coil and the first and second conducting pads are formed in a conducting layer deposited on the first face of the medium.

8. Medium according to claim 6, comprising a fifth conducting pad connected to the internal end of the antenna coil, a sixth conducting pad opposite the fifth conducting pad on a second face of the medium, and an electric link between the sixth conducting pad and the third conducting pad.

9. Medium according to claim 6, wherein the medium is a card comprising an embossing zone intended to receive inscriptions by deformation of the card, the antenna coil comprising in the embossing zone sections of conductor track that are widened to avoid being cut when embossing the card, the widened sections being pierced with orifices to avoid the propagation of cracks when embossing the card.

10. An object integrating a contactless microcircuit, comprising a medium according to claim 6, and a microcircuit fixed to the medium and comprising third and fourth conducting pads connected to connection terminals of a contactless microcircuit, the third and fourth conducting pads respectively forming with the first and second conducting pads two capacitors mounted in series with the antenna coil.

11. Object according to claim 10, wherein the microcircuit comprises a double contact and contactless communication interface.
